(19) United States
(12) Patent Application Publication
(10) Pub. No.: US 2012/0291602 A1
(43) Pub. Date: Nov. 22, 2012

(54) PRODUCTION SYSTEM FOR PORTIONING FOOD

(76) Inventor: Christoph Eckhardt, Breidenbach (DE)

(21) Appl. No.: 13/446,287

(22) Filed: Apr. 13, 2012

(30) Foreign Application Priority Data
Apr. 14, 2011 (DE) 102011017101.0

(51) Int. Cl. B26D 5/00; G05B 15/00

(52) U.S. Cl. 83/76.9; 700/83

(57) ABSTRACT

A production system for portioning food is provided, wherein the production system comprises at least one cutting machine for food, a display device, a selection unit and a control command unit. The display device comprises a first display region and a second display region, wherein in the first display region, possible output products of the cutting machine are displayed. By means of the selection unit, the user can select an output product from possible output products of the cutting machine which are displayed in the first display region. This selected output product is allocated to the second display region. The control command unit is adapted to convert an output product of the cutting machine allocated to the second display region into control commands for the cutting machine.

### CROSS-REFERENCE TO RELATED APPLICATIONS

This application claims priority to German Patent Application 10 2011 107 101.0 filed on Apr. 14, 2011, which is hereby incorporated by reference in its entirety.

### BACKGROUND

The present disclosure provides a production system that can portion food.

Production systems for portioning food products must perform ever more complex tasks. Apart from the requirement that a production system should be able to portion different kinds of food, for example sausage or cheese of most diverse shapes, the demands on the output portions become ever more multifarious. Current production systems for portioning food here often comprise a cutting device, also referred to as slicer, with a downstream packaging means. Such production systems can furthermore comprise peeling machines, loading buffers, inserters, pick-and-place robots, multilayer buffers or further machines.

To achieve a desired end product, product and recipe parameters must be set for each machine. As the number of machines employed in such a production system rises, the complexity of this task also increases. For example, if a parameter of the cutting machine is changed, parameters of the packing machine must also be correspondingly adapted so that the machines optimally work together. This is sometimes a complex and time-consuming task.

### SUMMARY

One aspect of the disclosure is to simplify the control of a production system for portioning food. A production system for portioning food comprises at least one cutting machine for food, one display device, one selection unit and one control command unit. The display device comprises a first display region and a second display region, wherein the display device is adapted to display possible output products of the cutting machine in the first display region. By means of the selection unit, a user can select an output product from possible output products of the cutting machine which are displayed in the first display region. The selection unit is furthermore adapted to allocate an output product of the first display region selected by the user to the second display region. Finally, the control command unit is adapted to convert an output product of the cutting machine allocated to the second display region into control commands for the cutting machine.

Furthermore, a machine-readable storage medium is provided which comprises computer executable instructions that, when executed by a computer, cause the computer to perform a method of controlling a production system for portioning food. The production system comprises at least one cutting machine. The method first displays possible output products of the cutting machine in a first display region of a display device. If a selection of an output product from the possible output products of the cutting machine is received by a user, the method allocates the selected output product to the second display region of the display device. Finally, the output product allocated to the second display region is converted into control commands for the cutting machine.

Finally, a device for controlling a production system comprising a first and a second machine is provided. This controlling device comprises a display device, a selection unit, and a control command unit. On the display device, possible output products of the first and the second machines are displayed. By means of the selection unit, the user can select an output product that is displayed on the display device. Finally, the control command unit is adapted to convert a selected output product of the first machine into control commands for the first and the second machines.

### BRIEF DESCRIPTION OF THE DRAWINGS

The accompanying drawings are incorporated into and form a part of the specification for the purpose of explaining the principles of the disclosure. The drawings are not to be construed as limiting the disclosure to only the illustrated and described examples of how the disclosure can be made and used. Further features and advantages will become apparent from the following and more particular description of the disclosure, as illustrated in the accompanying drawings. The drawings show in detail:

FIG. 1A: a schematic representation of a production system for portioning food;

FIG. 1B: a schematic representation of a device for controlling a production system for portioning food;

FIG. 2: a schematic representation of a display device that is used for controlling the production system for portioning food;

FIG. 3: a schematic representation of a display device that is used for controlling the production system for portioning food;

FIG. 4: a schematic representation of a display device that is used for controlling the production system for portioning food; and

FIG. 5: a flow chart for controlling the production system for portioning food.

### DETAILED DESCRIPTION

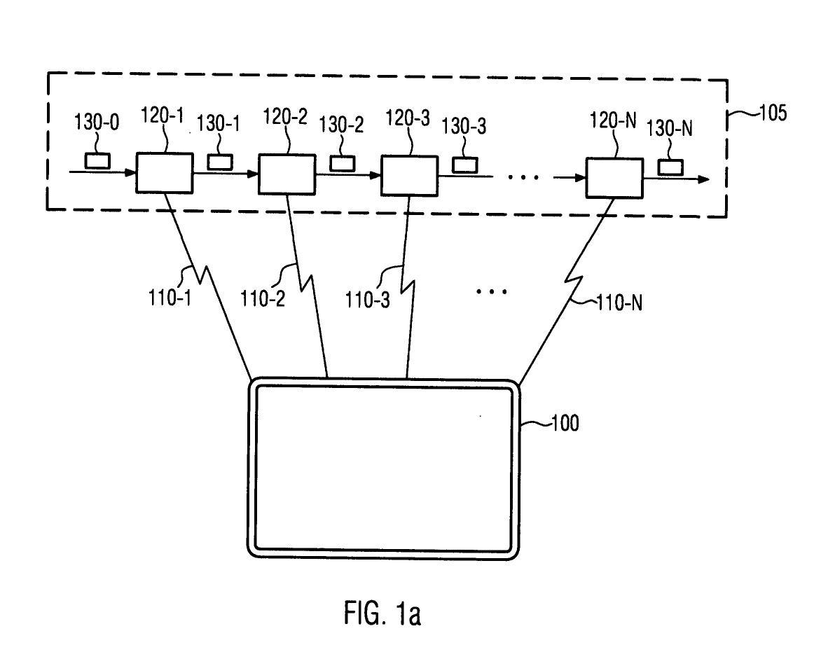

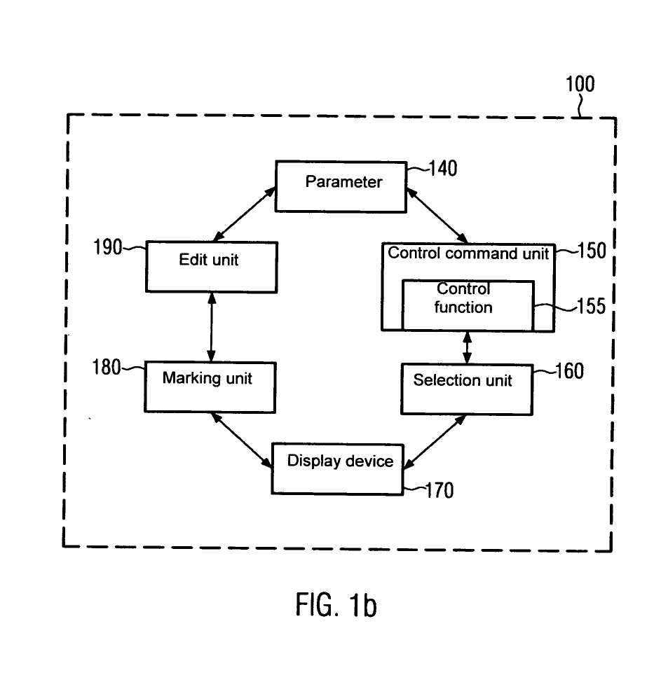

FIG. 1A shows a schematic representation of a production system for portioning food. As can be taken from FIG. 1A, a production system 105 for portioning food, such as sausage or cheese of most diverse original shapes, comprises one or more machines (or components) 120-1, 120-2, 120-3, . . . , 120-N. Here, an original product 130-0 is converted into an end product 130-N. The output product of a machine may be the input product of a subsequent machine. For example, the output product 130-1 of the machine 120-1 of FIG. 1A is simultaneously the input product 130-1 of the machine 120-2. The output product of the machine 120-2 is the product 130-2 which serves as input product of the machine 120-3. The last machine or component of the production device 105, i.e. 120-N, finally outputs the output product 130-N.

The production system 105 for portioning food may comprise, for example, loading buffers, multilayer buffers, peeling machines, slicers, inserters, pick-and-place robots, food robots and packing machines. So, in one example, the machine 120-1 may correspond to a loading buffer, the machine 120-2 to a peeling machine, the machine 120-3 to a cutting machine, and the machine 120-N to a packing machine. In this example, the input product 130-0 may be a sausage which is inserted into the loading buffer 120-1. The loading buffer provides its output product 130-1 to the peeling machine 120-2. The output product 130-2 of the peeling machine is the peeled sausage which is provided to the cutting machine 120-3. The cutting machine 120-3 produces a portion 130-3 from the peeled sausage which is finally packed by the packing machine 120-N. The end product 130-N is here the packed, sliced sausage.

The production system 105 is controlled by means of the control device 100 which is either part of the production system 105 or located outside the production system 105. The control device 100 may be a programmable device, for example a computer, with input and output devices. The control device 100 is shown in detail in FIG. B and may be, for example, a tablet computer or a smartphone having a touch-sensitive touch screen surface. A tablet computer is characterized in that the electronics of the computer is integrated in the display device. The control device may also comprise a touch screen display serving as input and output device, while the electronics of the computer is not integrated in the display device. The control device may also be a PC or a notebook wherein the input device is, for example, a keyboard and/or a mouse, and the output device is a monitor which either comprises a touch-sensitive surface or not.

The control device 100 is in connection with the production system 105, as is schematically shown in FIG. 1A. The control device 100 may communicate with each machine 120-1, 120-2, 120-3, . . . , 120-N via communication channels 110-1, 110-2, 110-3, . . . , 110-N. The communication channels 110-1, 110-2, 110-3, . . . , 110-N may be wire or wireless channels.

FIG. 1B shows a schematic representation of a control device 100. Here, a display of elements not essential for the disclosure, such as processors or memories, is omitted. The control device 100 comprises a display device 170 which may be embodied as touch screen. Apart from this, the control device 100 comprises a selection unit 160 and a control command unit 150. The control device 100 may also comprise a marking unit 180, an edit unit 190, and a memory 140 in which recipe and production parameters of the machines 120-1, 120-2, 120-3, . . . , 120-N of the production system 105 are stored. Apart from this, the control command unit 150 may comprise a control function 155. The units 150, 160, 180 and 190 may be implemented as software or hardware.

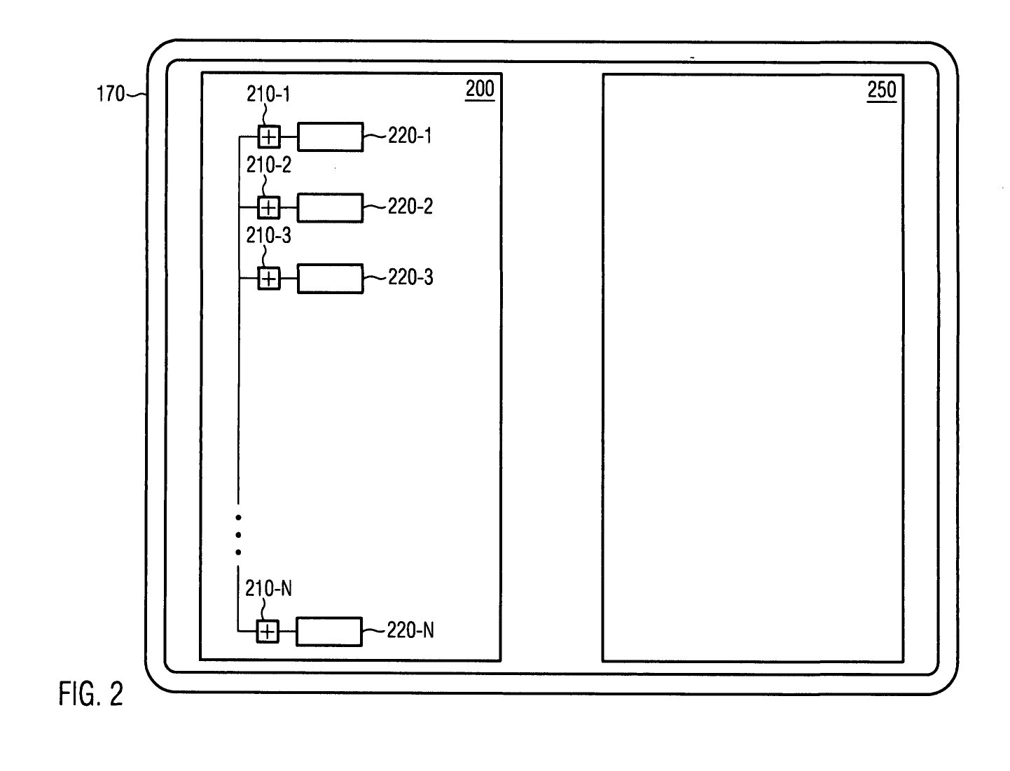

The functionality of the control device 100 with the units 140, 150, 155, 160, 170, 180 and 190 will now be described with reference to FIGS. 2 to 5. Here, the control device 100 controls the production system 105 of FIG. 1A. However, the control device 100 is not restricted to controlling production systems for portioning food but may principally be employed for controlling any type of production system or machine line.

FIG. 2 shows a first view of the display device 170 of the control device 100 which controls the production system 105. Here, the display device may comprise a first display region 200 and a second display region 250. In the first display region 200, representations 220-1, 220-2, 220-3, . . . , 220-N are displayed. Each representation 220-1, 220-2, 220-3, . . . , 220-N uniquely represents one machine 120-1, 120-2, 120-3, . . . , 120-N of the production system 105. For example, representation 220-1 represents the machine 120-1, representation 220-2 the machine 120-2, representation 220-3 the machine 120-3, and representation 220-N the machine 120-N. The representations 220-1, 220-2, 220-3, . . . , 220-N may be graphical and/or descriptive. For example, a realistic picture or an animation of the machine to be represented is shown.

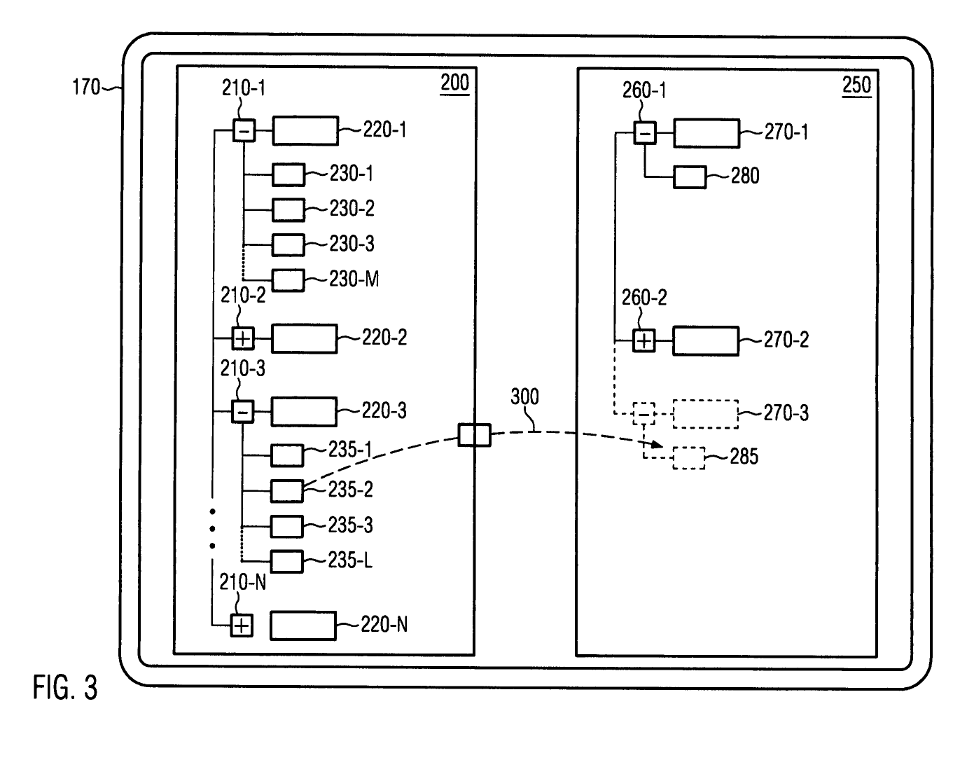

The representations 220-1, 220-2, 220-3, . . . , 220-N may be organized in the first display region 200 as a tree structure. The tree structure represents the configuration of the production system 105 which is controlled. To each representation 220-1, 220-2, 220-3, . . . , 220-N, a symbol 210-1, 210-2, 210-3, . . . , 210-N is allocated which permits access to possible output products of the respective machine represented by the allocated representation. The access may be realized as pull-down menu. If a user selects, for example, the symbol 210-1 by touching it on a touch screen or by a mouse click, possible output products 230-1, 230-2, 230-3, . . . , 230-M of the machine 120-1, which are represented by representation 220-1, are uniquely displayed as a pull-down menu as can be seen in FIG. 3. Here, too, the representations 230-1, 230-2, 230-3, . . . , 230-M may be graphic representations of the output products of the machine, animations and/or descriptions. In FIG. 3, the possible output products of the machine 120-3, which is represented by representation 220-3, are moreover displayed. The machine 120-3 in this example has possible output products 235-1, 235-2, 235-3, . . . , 235-L.

As mentioned above, in the display region 200, representations which represent machines of the production system 105 are displayed. Moreover, access to possible output products of the machines is permitted to a user by means of symbols 210-1, 210-2, 210-3, . . . , 210-N. In contrast, in the display region 200, it is possible to only display the possible output products of the machines of the production system 105. Moreover, the output products of a machine may be displayed not before a user has selected a representation 220-1, 220-2, 220-3, . . . , 220-N.

The control device 100 provides a selection unit 160 for the user by means of which the user may select a possible output product of a machine. If the display device 170 of the control device 100 is realized as a touch screen, a user may select a possible output product, for example, by touching a possible output product on the touch screen for an extended period, by touching a possible output product on the touch screen twice within a predefined period, by shifting a possible output product on the touch screen into the second display region 250 by drag & drop, or by means of other methods. If the input device is a mouse or the like, the user may select an output product, for example, by a click, by a double click, or by shifting it into the second display region 250 by drag & drop. The user may also select a possible output product of the first display region 200 in another way.

Possible output products the user selects in the first display region 200 are allocated to the second display region. This allocation may be performed by the selection unit 160. Output products allocated to the second display region 250 may be displayed in the second display region 250 of the display device.

FIG. 3 shows the display of a display device 170 in which possible output products of the first display region 200 have been selected. As was mentioned, a selection of a possible output product of the first display region 200 causes an allocation of the selected possible output product to the second display region 250. The selection of a possible output product of a machine may lead to the representation of the machine and/or the representation of the selected possible output product being displayed in the second display region 250. In the example of FIG. 3, a user has selected a possible output product of the machine 120-1 which is represented by the representation 220-1 in the first display region 200. Accordingly, an allocation of the selected output product to the second display region 250 has taken place. In one example, the representation 270-1 is displayed in the second display region 250 which corresponds to the representation 220-1 and thus represents the machine 120-1. Furthermore, in the second display region 250, the selected possible output product 280 is displayed. The representation 280 accordingly corresponds to the selected representation of representations 230-1, 230-2, 230-3, . . . , 230-M.

The selection of a possible output product of the first display region 200 is described again with reference to representation 230-3 which represents the machine 120-3. The user here selects the possible output product 235-2 of the machine 120-3. The selection is symbolically represented by the dashed arrow 300 in FIG. 3. For example, the user shifts the representation 235-2 into the second display region 250 by means of drag & drop. Upon selection, the representation 235-2 is allocated to the second display region 250. In one embodiment, this leads to the representation 285 appearing in the second display region 250 and being displayed. The representation 285 here corresponds to the selected representation 235-2. Moreover, the representation 270-3 may be also displayed in the second display region 250 which corresponds to the representation 220-3 of the first display region 200.

So, by simply selecting possible output products in the first display region 200, a program for controlling the production system 105 may be set up. The control command unit 150 is especially adapted to convert the selected output products which are allocated to the second display region 250 into control commands for the production system 105.

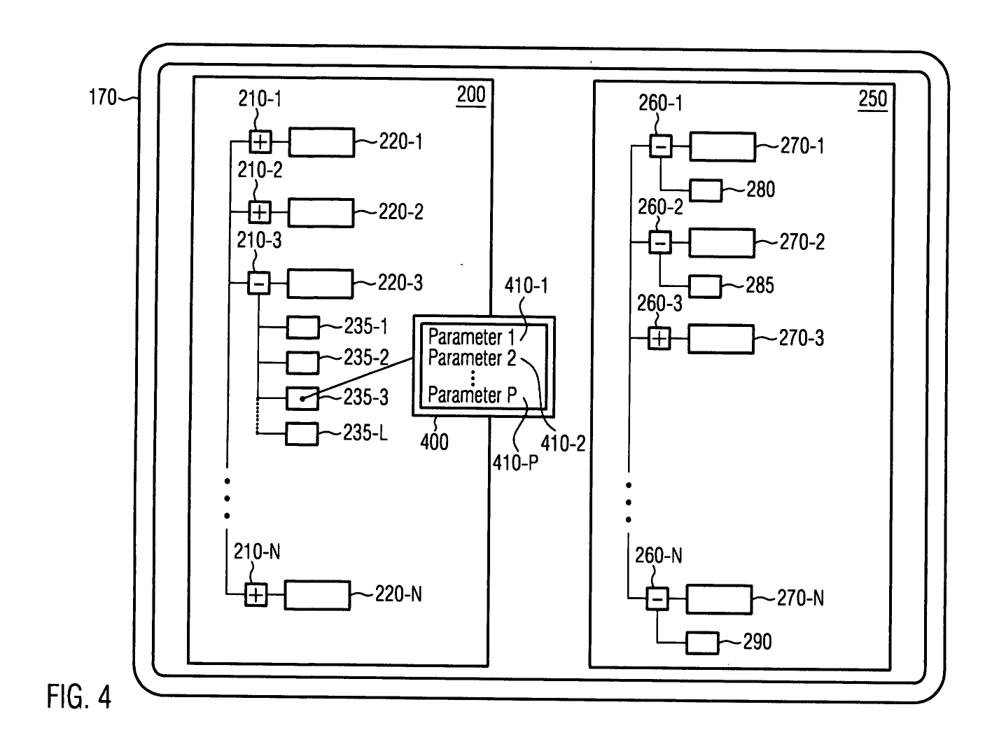

FIG. 4 here shows a completely set up control program for the production system 105. The control program is here generated by the control command unit 150 of the control device 100 by converting the output products which are allocated to the second display region 250 into control commands for the machines 120-1, 120-2, 120-3, . . . , 120-N of the production system 105.

A selected output product may be converted into control commands for the machine which produces the selected output product. Since the output products of the machines 120-1, 120-2, 120-3, . . . , 120-(N-1) are the input products of the machines 120-2, 120-3, . . . , 120-N, a selected output product may be converted into control commands for the machine which produces the selected output product, and in addition into control commands for at least one further machine of the production system. Accordingly, the control command unit 150 is adapted to control the other machines of the production system such that they may utilize output products of the preceding machines as input products. This makes cumbersome programming of each machine superfluous.

As in the first display region 200, in the second display region 250, too, the representations 270-1, 270-2, 270-3, . . . , 270-N which correspond to the representations 220-1, 220-2, 220-3, . . . , 220-N of the first display region 200 and represent the machines 120-1, 120-2, 120-3, . . . , 120-N may be organized as tree structure. Here, the selected output products 280, 285 and 290 may also be realized as a pull-down menu which may be minimized for a better overview. For example in FIG. 4, the selected output product of the machine 120-3 which is represented by representation 270-3 is minimized. Via 260-3, a user has access to a pull-down menu which displays the selected output product of the machine 120-3. The allocated output product may also be displayed if the corresponding representation 270-1, 270-2, 270-3, . . . , 270-N of the machine is selected in the second display region 250.

In FIG. 4, a further aspect of the present disclosure is shown. A further display region 400 may be generated dynamically as soon as a user marks a possible output product which is displayed in the first display region 200 or a selected output product which is displayed in the second display region 250. A marking may here be effected by touching the possible/selected output product on a touch screen for an extended period or by pressing a mouse button. Marking a possible/selected output product is provided, for example, by the marking unit 180. Here, the control device 100 may unambiguously distinguish whether a user marks or selects a possible output product of the first display region 200. For example, in devices with a touch screen display, a selection may take place by shifting a representation of the possible output product into the second display region 250 by means of drag & drop, whereas a marking by touching the representation of the possible output product for an extended period on the touch screen is done without shifting the representation.

The output product of each machine 120-1, 120-2, 120-3, . . . , 120-N of the production system 105 may be changed by variable product and/or recipe parameters (also simply referred to as parameters) of the respective machine. In the memory 140, parameters are allocated to each possible output product of each machine. If the machine is set with the allocated parameters of a possible output product, the possible output product is the actual output product of the machine.

In the display region 400, parameters 410-1, 410-2, . . . , 410-P of the machine are displayed which are allocated to the marked possible output product and stored, for example, in the memory 140. The parameters 410-1, 410-2, . . . , 410-P may also be represented graphically (by means of a picture or animation) and/or descriptively. This marking function may also be applied to already selected output products in the second display region 250. In the example of the production system for portioning food, for example, parameters for a cutting machine may be slices per portion, weight per mobile table and slice thickness.

The control device 100 may furthermore provide an edit unit 190 which permits the user to change the parameters 410-1, 410-2, . . . , 410-P. These changed parameters are then allocated to the marked possible/selected output product and stored in the memory 140. The allocation of the parameters is maintained if a possible output product of the first display region 200 is selected and allocated to the second display region 250. Accordingly, the same parameters are allocated to a selected output product allocated to the second display region 250 as the possible output product of the first display region 200 which corresponds to the selected output product of the second display region 250 and vice versa.

The control command unit 150 has access to the output products allocated to the second display region 250 and thus selected and to the memory 140 in which the parameters which are allocated to the selected output products are stored. The control command unit 150 generates control commands for the production system 105 depending on the parameters that are allocated to the selected output products which are thus allocated to the second display region 250. If a user changes parameters which are allocated to a possible/selected output product by means of the edit unit 190, the control commands for the production system 105 generated by the control command unit 150 are also changed accordingly.

The output products of the machines 120-1, 120-2, 120-3, . . . , 120-(N-1) of the production system 105 are, as already mentioned, input products of the machines 120-2, 120-3, . . . , 120-N. Accordingly, a change of the output product of a machine of the production system may require the adaptation of parameters of the following machines. This adaptation of the parameters may take place automatically by the control device 100.

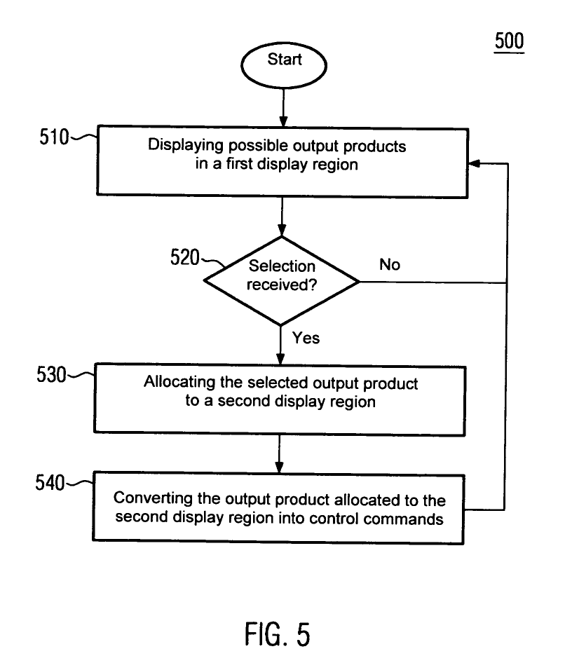

FIG. 5 shows a method which is carried out by the control device 100 for setting up a program for controlling the production system 105. The production system may here comprise at least one cutting machine for food. The method is present as instructions on a machine-readable storage medium that can be executed by a computer. The instructions that can be executed by a computer cause a computer to execute the method 500.

In a step 510, possible output products of machines of the production system 105 are displayed in the first display region 200 of a display 170 of the control device 100. In step 520, it is verified whether a user has selected a possible output product which is displayed in the first display region 200. If this is not the case, in step 510, the possible output products are further displayed in the first display region 200. If, however, a user selects a possible output product in step 520 which is displayed in the first display region 200, the selected output product is allocated to the second display region 250 in step 530. In step 530, the selected output product may be moreover displayed in the second display region 250. The control device then converts, in step 540, the output product which is allocated to the second display region 250 into control commands for the production system 105. The control device 100 may convert the output product allocated to the second display region 250 into control commands for the machine whose output product is the output product allocated to the second display region 250. As an alternative, the control device 100 may convert the output product allocated to the second display region 250 into control commands for the machine whose output product is the output product allocated to the second display region, and into control commands for at least one further machine. The method then carries out again step 510 and is run through again.

Thus, the present disclosure provides a simplified method of programming a control device for a production system 105 for portioning food. A production system 105 for portioning food comprises here at least one cutting machine (slicer). The cutting device is thus one of the machines 120-1, 120-2, 120-3, . . . , 120-N. The representations 220-1, 220-2, 220-3, . . . , 220-N of the machines 120-1, 120-2, 120-3, . . . , 120-N in the first display region 200 may reproduce the configuration of the current line, i.e. the production system 105. If the current line is expanded by a machine, the new configuration may be represented by means of a module library. For this, a user may select the new machine in the production system from the module library and insert it into the first display region 200. Possible output products of the new machine are also made available by the module library, as well as possibly necessary adaptations of the control of the other machines in the production system 105.

The programming of the complete production system 105 takes place by selecting possible output products of the machines represented in the first display region 250. In the process, the control device 100 automatically generates control commands from the selected output products. The control device 100 may moreover be adapted to perform a plausibility check to check whether the selected output products allocated to the second display region 250 are compatible. For this, the control device 100 comprises the control function 155 which is located, for example, in the control command unit 150. If the output products allocated to the second display region 250 are not compatible, the control device 100 may suggest alternative output products the user can then select.

Furthermore, the present disclosure supports user groups. Here, a user sets up, for example, various control programs for the production system 105 and stores them on the control device 100 under a unique user account. If a user later uniquely identifies himself/herself to the control device 100 he/she has access to the control programs for the production system generated by him/her under the user account. Subsequently, he/she may select a stored program and thus quickly reprogram the production system for another end product.

Thus, the present disclosure facilitates the programming of a production system consisting of several machines. A user selects graphical representations of desired output products, and the control device of the disclosure automatically establishes a control program for the complete production system from this. Thus, erroneous inputs are prevented, leading to a considerable saving of time in the commissioning or conversion of a production system. The disclosure furthermore provides means which permit in a simple manner to change the configuration of a production system in the control program.

It will be apparent to those skilled in the art that various modifications, variations and improvements of the present disclosure may be made in the light of the above teachings and within the purview of the appended claims without departing from the spirit and intended scope of the disclosure. In addition, those areas in which it is believed that those of ordinary skill in the art are familiar, have not been described herein in order to not unnecessarily obscure the disclosure described herein. Accordingly, it is to be understood that the disclosure is not to be limited by the specific illustrative embodiments, but only by the scope of the appended claims.

1. A production system for portioning food, wherein the production system comprises at least one cutting machine for food, comprising:
a display device comprising a first display region and a second display region, the display device being adapted to display possible output products of the cutting machine in the first display region;
a selection unit to select an output product from possible output products of the cutting machine which are displayed in the first display region, the selection unit to allocate an output product selected by the user from the first display region to the second display region; and
a control command unit to convert an output product of the cutting machine which is allocated to the second display region into control commands for the cutting machine.

2. The production system of claim 1 further including a second machine, wherein:
the display device to display possible output products of the second machine in the first display region,
the user is enabled to select an output product from possible output products of the further machine which are displayed in the first display region, said selection unit is to allocate an output product of the further machine selected by the user to the second display region, and
the control command unit is to convert an output product of the second machine which is allocated to the second region into control commands for the further machine.

3. The production system of claim 2, wherein the display device displays the cutting machine and the second machine in the first and second display regions, and the user is enabled to select, by means of the selection unit, the cutting machine and the further machine which are displayed in the first region, the display device being further adapted to:
display possible output products of the cutting machine in the first display region when the user selects the cutting machine,
display possible output products of the further machine in the first display region when the user selects the second machine,
display the cutting machine in the second display region when the user selects an output product of the cutting machine in the first region, and
display the further machine in the second display region when the user selects an output product of the second machine in the first display region.

4. The production system of claim 1, wherein the possible output products of the first display region are represented graphically and can be shifted into the second display region, and wherein the user selects an output product from the possible output products of the first display region by the user shifting the output product into the second display region.

5. The production system of claim 1, wherein the display device is as a touch screen.

6. The production system of claim 2, wherein the user has selected an output product of the cutting machine and an output product of the further machine, and wherein the control unit performs a control function, the control function includes checking whether the selected output products are compatible.

7. The production system of claim 2, wherein the control unit converts an output product of the cutting machine allocated to the second display region into control commands for the cutting machine and the second machine, and/or to convert an output product of the further machine allocated to the second display region into control commands for the further machine and the cutting machine.

8. The production system of claim 2, wherein the display device displays output products of the cutting machine and the second machine allocated to the second display region in the second display region.

9. The production system of claim 8, further comprising a marking unit by means of which the user can mark an output product displayed in the first or second display region, wherein parameters of the production system are allocated to each output product, and wherein the display device dynamically generates a third display region when a user marks a possible output product in the first or in the second display region by means of the marking unit, and to display the parameters of the production system allocated to the marked output product in the third display region.

10. The production system of claim 9, further comprising an edit unit by means of which the user can change parameters allocated to an output product and displayed in the third display region, wherein the control commands into which a first output product is converted differ from control commands into which a second output product is converted when parameters allocated to the first output product differ from the parameters allocated to the second output product.

11. A device for controlling a production system comprising a first and a second machine, comprising:
a display device to display products of the first and the second machine;
a selection unit to select an output product which is displayed on the display device; and
a control command unit to convert a selected output product of the first machine into control commands for the first and the second machines.

12. A computer-readable storage medium comprising computer-executable instructions that, cause a computer to perform a method for controlling a production system for portioning food, wherein the production system comprises at least one cutting machine, and wherein the method comprises the following steps:
displaying possible output products of the cutting machine in a first display region of a display device;
receiving a selection of an output product from the possible output products of the cutting machine by a user;
allocating the selected output product to a second display region of the display device; and
converting the output product of the cutting machine allocated to the second display region into control commands for the cutting machine.

13. The computer-readable storage medium of claim 12, wherein the production system includes a second machine, said method further comprises:
displaying possible output products of the second machine in the first display region of the display device;
receiving a selection of an output product from the possible output products of the second machine by the user;
allocating the selected output product of the second machine to the second display region of the display device; and
converting the output product of the second machine allocated to the second display region into control commands for the second machine.

14. The computer-readable storage medium of claim 13, wherein receiving a selection comprises shifting the possible output product from the first display region into the second display region.

15. The computer-readable storage medium of claim 14, wherein the method further comprises:
converting the output product of the cutting machine allocated to the second display region into control commands for the second machine; and
converting the output product of the second machine allocated to the second display region into control commands for the cutting machine.

16. The computer-readable storage medium of claim 13, further comprising:
displaying the output products of the cutting machine and the second machine allocated to the second display region in the second display region.

17. The computer-readable storage medium of claim 16, wherein to each output product displayed in the first or the second display region, parameters of the production system are allocated, the method further comprises:
marking an output product displayed in the first or second display region by the user;
generating a third display region in the display device in response to the marking of the output product and displaying the parameters of the production system allocated to the marked output product in the third display region.

18. The computer-readable storage medium of claim 17, wherein the control commands into which a first output product is converted differ from the control commands into which a second output product is converted when parameters allocated to the first output product differ from the parameters allocated to the second output product, and wherein the method further comprises:
changing the parameters allocated to an output product and displayed in the third display region by the user.
